(19) United States
(12) Patent Application Publication
(10) Pub. No.: US 2019/0360760 A1
(43) Pub. Date: Nov. 28, 2019

(54) VAPOR CHAMBER

(71) Applicant: FURUKAWA ELECTRIC CO., LTD., Tokyo (JP)

(72) Inventors: Hirofumi AOKI, Tokyo (JP); Yoshikatsu INAGAKI, Tokyo (JP)

(73) Assignee: FURUKAWA ELECTRIC CO., LTD., Tokyo (JP)

(21) Appl. No.: 16/533,637

(22) Filed: Aug. 6, 2019

Related U.S. Application Data
(63) Continuation of application No. PCT/JP2018/004025, filed on Feb. 6, 2018.

(30) Foreign Application Priority Data
Feb. 7, 2017 (JP) 2017-020502

(51) Int. Cl. F28D 15/02; B23K 26/21; F28F 21/08

(52) U.S. Cl. CPC F28D 15/0233; F28D 15/046; F28F 21/08; B23K 26/21

(57) ABSTRACT

To provide a vapor chamber with which distortion of a container is reduced regardless of the kind of the material of the container and generation of pin-holes in a melted part of the container is prevented. The vapor chamber includes a container having a hollow cavity part, the container being formed by laminating one tabular member and another tabular member facing the one tabular member; a working fluid enclosed in the cavity part; and a wick structure provided in the cavity part. An outer peripheral part of the cavity part is sealed by welding. A melted part formed by the welding runs through the one tabular member, while the melted part does not run through the other tabular member.

### CROSS REFERENCE TO RELATED APPLICATIONS

The present application is a continuation application of International Patent Application No. PCT/JP2018/004025 filed on Feb. 6, 2018, which claims the benefit of Japanese Patent Application No. 2017-020502, filed on Feb. 7, 2017. The contents of these applications are incorporated herein by reference in their entirety.

### BACKGROUND

### Technical Field

The present disclosure relates to a vapor chamber in which distortion of a container is reduced and generation of pin-holes at a welded part of the container is prevented.

### Background

Heating values of electric components such as semiconductor elements and the like loaded on electric and electronic apparatuses have increased due to highly-packed mounting and the like caused by implementing sophisticated functions so that, recently, cooling of those components has become more important. As a cooling method of such electronic components, a vapor chamber (flat heat pipe) may be used in some cases.

For example, proposed is a flat heat pipe in a laminated structure acquired by placing an intermediate plate between a top plate and a back plate which are flat plates made of a metal material such as aluminum or copper, and joining those plates by laser welding or the like while being fixed by jigs (Japanese Patent Application Laid-Open No. 2001-336889). Further, joining of the top plate and the back plate by laser welding is conducted such that a laser melted part runs through the top plate and the back plate in a plate thickness direction.

However, aluminum, copper, and the like have relatively higher reflectance for laser beams compared to other metals such as stainless and the like used for materials of containers, so that relatively higher energy density is required for laser welding. In such case, distortion may be generated in the containers due to the heat generated by the high energy density.

Further, in the case where relatively higher energy density is required for laser welding, the melted metal material may fall off before being solidified and pin-holes may be generated in the laser welded part.

The present disclosure is related to providing a vapor chamber in which distortion of a container is reduced and generation of pin-holes in a welded part of the container is prevented regardless of the kind of the material of the container.

### SUMMARY

According to a first aspect of the present disclosure, a vapor chamber includes: a container having a hollow cavity part, the container being formed by laminating one tabular member and another tabular member facing the one tabular member; a working fluid enclosed in the cavity part; and a wick structure provided in the cavity part, an outer peripheral part of the cavity part being sealed by welding, in which a melted part formed by the welding runs through the one tabular member, while the melted part does not run through the other tabular member.

In the first aspect described above, the two laminated tabular members forming the container are joined at their peripheral edge parts by welding. The melted part runs through one tabular member out of the two tabular members in the plate thickness direction, while the melted part does not run through the other tabular member in the plate thickness direction. Thus, according to the first aspect described above, an optical beam is irradiated from the one tabular member side and welding is conducted under a state where the optical beam runs through the one tabular member in the plate thickness direction while the optical beam does not run through the other tabular member in the plate thickness direction. Therefore, a welding mark (for example, a weld bead or the like) is observed on an appearance of the one tabular member of the container, whereas no welding mark (for example, a weld bead or the like) is observed on an appearance of the other tabular member. Further, “melted part” mentioned above means an area of the tabular member melted and solidified by being heated by irradiation of the optical beam at the time of welding.

According to a second aspect of the present disclosure, a vapor chamber includes: a container having a hollow cavity part, the container being formed by laminating one tabular member, another tabular member facing the one tabular member, and a spacer member provided between the one tabular member and the other tabular member; a working fluid enclosed in the cavity part; and a wick structure provided in the cavity part, an outer peripheral part of the cavity part being sealed by welding, in which a melted part formed by the welding runs through the one tabular member, while the melted part on the one tabular member side does not run through the spacer member, and the melted part runs through the other tabular member, while the melted part on the other tabular member side does not run through the spacer member.

According to a third aspect of the present disclosure, in the vapor chamber, plate thickness in the melted part of the one tabular member is thinner than plate thickness in the melted part of the other tabular member.

According to a fourth aspect of the present disclosure, in the vapor chamber, thickness of the melted part of the other tabular member is 50 to 400% of the plate thickness in the melted part of the one tabular member.

According to a fifth aspect of the present disclosure, in the vapor chamber: thickness of the melted part of the spacer member on the one tabular member side is 50 to 400% of plate thickness in the melted part of the one tabular member; and thickness of the melted part of the spacer member on the other tabular member side is 50 to 400% of plate thickness in the melted part of the other tabular member.

According to a sixth aspect of the present disclosure, in the vapor chamber, maximum width of the melted part on a top surface of the container is 20 to 60% of width of the spacer member in the melted part.

According to a seventh aspect of the present disclosure, in the vapor chamber, a recessed part forming the cavity part is provided in the other tabular member.

According to an eighth aspect of the present disclosure, in the vapor chamber: a recessed part forming the cavity part is provided in the other tabular member; the plate thickness in the melted part of the one tabular member is 30 to 300 μm; and the plate thickness in the melted part of the other tabular member is 100 μm of more.

According to a ninth aspect of the present disclosure, in the vapor chamber, thickness of the melted part of the other tabular member is 10 to 90% of plate thickness in the melted part of the other tabular member.

According to a tenth aspect of the present disclosure, in the vapor chamber, the welding is laser welding, and the melted part is a laser melted part.

According to an eleventh aspect of the present disclosure, in the vapor chamber, a material of the container is at least one kind of metal selected from a group consisting of stainless steel, copper, copper alloy, aluminum, aluminum alloy, tin, tin alloy, titanium, titanium alloy, nickel, and nickel alloy.

According to the aspects of the present disclosure, when sealing the outer peripheral part of the cavity part by irradiating the optical beam from the one tabular member side, the optical beam does not run through the other tabular member in the plate thickness direction. Thus, the energy density of the optical beam can be reduced regardless of the kind of the material of the container. Accordingly, the heat generated at the time of welding can be inhibited, so that distortion of the container as the welding subject can be reduced. Further, because the energy density of the optical beam can be reduced, generation of pin-holes can be prevented even with copper or aluminum as a container material with which pin-holes are easily generated in the melted part. Thereby, an excellent junction property can be acquired.

Further, because the optical beam does not run through the other tabular member in the plate thickness direction, generation of sputters that are melted-state metal powders can be prevented. As a result, contamination of the vapor chamber as well as the welding jigs and the like can be prevented. Furthermore, because the optical beam does not run through the other tabular member in the plate thickness direction, there is no weld bead that is a protruded welding mark generated in the other tabular member. As a result, work for removing the weld bead from the other tabular member can be omitted. Moreover, as described above, the energy density of the optical beam can be reduced and the work for removing the weld bead from the other tabular member can be omitted, so that it is possible to cut the production cost of the vapor chamber.

According to the aspects of the present disclosure, the plate thickness in the melted part of the one tabular member is thinner than the plate thickness in the melted part of the other tabular member. That is, in the melted part, the plate thickness of the one tabular member that is the tabular member positioned on the optical beam irradiation side is thinner than the plate thickness of the other tabular member, so that the energy density of the optical beam can be reduced further. As a result, distortion of the container can be reduced further.

According to the aspects of the present disclosure, the thickness of the melted part of the other tabular member is 10 to 90% of the plate thickness in the melted part of the other tabular member. Therefore, the junction reliability of the one tabular member and the other tabular member, reduction in distortion of the container, and prevention of generating pin-holes can be improved in a well-balanced manner.

### BRIEF DESCRIPTION OF THE DRAWINGS

FIG. 1 is an explanatory lateral sectional view of a vapor chamber according to a first embodiment of the present disclosure;

FIG. 2 is an explanatory lateral sectional view of a vapor chamber according to a second embodiment of the present disclosure;

FIG. 3 is an explanatory lateral sectional view of a vapor chamber according to a third embodiment of the present disclosure;

FIG. 4 is an explanatory lateral sectional view of a vapor chamber according to a fourth embodiment of the present disclosure; and

FIG. 5 is an explanatory lateral sectional view of a vapor chamber according to a fifth embodiment of the present disclosure.

### DETAILED DESCRIPTION

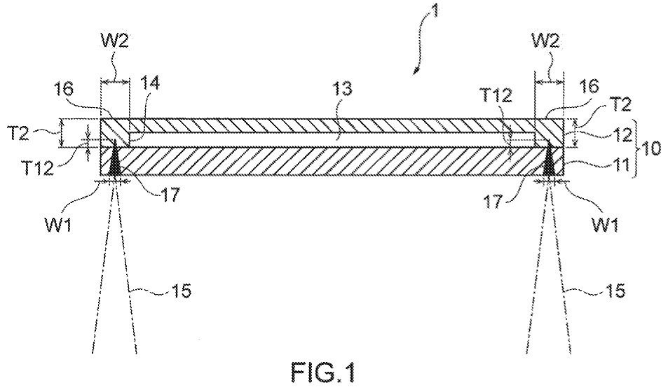

Hereinafter, a vapor chamber according to a first embodiment of the present disclosure will be described in details with reference to the accompanying drawings. As illustrated in FIG. 1, a vapor chamber 1 according to the first embodiment includes a container 10 having a hollow cavity part 13, and a working fluid (not shown) enclosed in the cavity part 13. Inside the cavity part 13, a wick structure (not shown) having a capillary force is housed. Through thermally connecting a heating element (not shown) as a cooling subject to an outer face of the container 10, the heating element is cooled.

The container 10 having the cavity part 13 is formed by laminating two tabular members facing each other, i.e., a tabular member 11 and another tabular member 12 facing the tabular member 11. Thus, the container 10 is in a two-layer structure. The tabular member 11 and the other tabular member 12 are laminated in a mutually superposing position on a plan view (in a mode viewed from a vertical direction with respect to a planar part of the vapor chamber 1).

Each of the tabular member 11 and the other tabular member 12 is a flat plate member. At a center part of the other tabular member 12, a recessed part 14 is provided when viewed from the tabular member 11. That is, the other tabular member 12 has the recessed part 14 on a surface facing the tabular member 11. Further, an area corresponding to the position of the recessed part 14 on a surface not facing the tabular member 11 is on a same plane as an area corresponding to a peripheral edge part of the recessed part 14. In the meantime, a center part of the tabular member 11 is in a planar shape where no recessed part 14 is provided. Thus, the recessed part 14 of the other tabular member 12 forms the cavity part 13 of the container 10. That is, a hollow part of the container 10 formed with an inner surface of the recessed part 14 of the other tabular member 12 and an inner surface of the tabular member 11 is the cavity part 13. The shape of the cavity part 13 on a plane view is not specifically limited, and can be selected as appropriate depending on the use condition and the like of the vapor chamber 1. Examples of the shape may be a rectangular shape, and the like.

In the vapor chamber 1, an outer peripheral part of the cavity part 13, i.e., an outer edge part 16 of the container 10, is laser-welded to seal the cavity part 13 so that airtightness is given to the cavity part 13. In the outer edge part 16 of the container 10 of the vapor chamber 1 to be laser-welded, plate thickness of the tabular member 11 is substantially the same or the same as plate thickness of the other tabular member 12. In the vapor chamber 1, the tabular member 11 and the other tabular member 12 are joined through irradiating a laser beam 15 to the outer edge part 16 of the container 10 from the tabular member 11 side. Thus, in the vapor chamber 1, the laser beam 15 is irradiated to the tabular member (i.e., the tabular member 11) where the recessed part 14 forming the cavity part 13 is not provided. The laser beam 15 is not irradiated to the tabular member (i.e., the tabular member 12) where the recessed part 14 forming the cavity part 13 is provided.

In FIG. 1, the laser beam 15 is irradiated from the vertical direction to the planar part of the tabular member 11. Through laser-welding the tabular member 11 and the other tabular member 12, a laser melted part 17 is formed in the outer edge part 16 of the container 10. Maximum width W1 of the laser melted part 17 on the top surface of the container 10 is not specifically limited. However, the maximum width W1 is preferable to be 20 to 60% of width W2 of the outer edge part 16 of the other tabular member 12, and more preferable to be 30 to 50%.

In the tabular member 11 to which the laser beam 15 is irradiated, the laser melted part 17 runs through the tabular member 11 in the thickness direction. In the meantime, in the other tabular member 12, the laser melted part 17 does not run through the tabular member 12 in the thickness direction. In the outer edge part 16 of the container 10 of the vapor chamber 1 to be laser-welded, the laser melted part 17 runs through the tabular member 11 in the thickness direction, while the laser melted part 17 does not run through the other tabular member 12 in the thickness direction.

From the above, a welding mark (for example, a weld bead or the like) is observed on an appearance of the tabular member 11 of the container 10, whereas no welding mark (for example, a weld bead or the like) is observed on an appearance of the other tabular member 12.

In the vapor chamber 1 where the laser melted part 17 does not run through the other tabular member 12, the energy density of the laser beam 15 can be reduced regardless of the kind of the material of the container 10. Thus, heat generated at the time of laser welding can be inhibited. Accordingly, distortion of the container 10 is reduced in the vapor chamber 1. Further, because the energy density of the laser beam 15 can be reduced, generation of pin-holes can be prevented even when the material the container 10 is copper or aluminum with which the pin-holes are easily generated in the laser melted part 17.

Further, generation of sputters as melted metal powders is prevented at the time of laser welding because the laser melted part 17 in the other tabular member 12 does not run through, so that contamination of the vapor chamber 1 as well as welding jigs and the like can be prevented. Furthermore, no weld bead as a protruded weld mark is generated in the other tabular member 12 where the laser melted part 17 does not run through, so that work for removing the weld bead from the other tabular member 12 can be omitted. Moreover, because the energy density of the laser beam 15 can be reduced and the work for removing the weld bead from the other tabular member 12 can be omitted, it is possible to cut the production cost of the vapor chamber 1.

Thickness T12 of the laser melted part 17 in the other tabular member 12 with respect to plate thickness T2 in the laser melted part 17 of the other tabular member 12 is not specifically limited as long as the laser melted part 17 does not run through the other tabular member 12 in the plate thickness direction. However, the lower limit value is preferable to be 10%, for example, and more preferably to be 20% in regards to the junction reliability of the laser welding. In the meantime, the upper limit value is preferable to be 90% and more preferable to be 80% in regards to securely preventing distortion of the container 10 and generation of the pin-holes. Note that the laser melted part 17 reaches the center part of the other tabular member 12 in the plate thickness direction in the vapor chamber 1, and the thickness of the laser melted part 17 in the other tabular member 12 in FIG. 1 is about 50% with respect to the plate thickness in the laser melted part 17 of the tabular member 12.

While the thickness of the vapor chamber 1 is not specifically limited, examples may be 0.30 to 10 mm. Also, while the thickness of the cavity part 13 is not specifically limited, examples may be 0.10 to 4.5 mm. Furthermore, while the plate thickness in the laser melted part 17 of the tabular member 11 and the other tabular member 12 is not specifically limited, examples may be 0.15 to 5.0 mm in plate thickness.

Examples of the material of the container 10 may be stainless steel, copper, copper alloy, aluminum, aluminum alloy, tin, tin alloy, titanium, titanium alloy, nickel, and nickel alloy.

The working fluid inserted into the cavity part 13 can be selected as appropriate according to the compatibility with the material of the container 10, and examples of the working fluid may be water, fluorocarbons, cyclopentane, ethylene glycol, and mixtures of those. While there is no specific limit set for the wick structure, examples may be a sinter of metal powders such as copper powders, a metal mesh formed with metal wires, grooves,and a nonwoven fabric.

An example of a laser emitting the laser beam 15 may be a laser capable of emitting a laser beam of a small condensing spot diameter (for example, condensing spot diameter of 20 to 200 μm). An example of the laser may be a fiber laser.

Next, a vapor chamber according to a second embodiment of the present disclosure will be described with reference to the accompanying drawings. Components same as the components of the vapor chamber according to the first embodiment of the present disclosure will be described by using same reference signs.

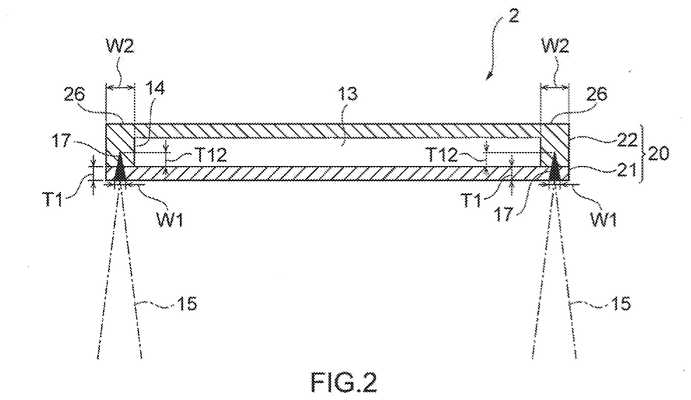

As described above, in the vapor chamber 1 according to the first embodiment, when irradiating the laser beam 15 to the tabular member 11 where the recessed part 14 forming the cavity part 13 is not provided, the plate thickness of the tabular member 11 is the same or substantially the same as the plate thickness of the other tabular member 12 in the outer edge part 16 of the container 10 to be laser-welded. Instead, as shown in FIG. 2, in a vapor chamber 2 according to the second embodiment, the plate thickness of a tabular member 21 where the recessed part 14 forming the cavity part 13 is not provided is thinner than the plate thickness of another tabular member 22.

In the vapor chamber 2, in an outer edge part 26 of a container 20 to be laser-welded, the laser melted part 17 runs through the tabular member 21 with relatively thinner plate thickness in the plate thickness direction while the laser melted part 17 does not run through the other tabular member 22 with relatively thicker plate thickness in the plate thickness direction. Therefore, a welding mark (for example, a weld bead or the like) is observed on an appearance of the tabular member 21 of the container 20, whereas no welding mark (for example, a weld bead or the like) is observed on an appearance of the other tabular member 22 in the vapor chamber 2 as well.

While the thickness of the vapor chamber 2 is not specifically limited, examples of the thickness may be 0.13 to 10 mm. Further, while the thickness of the cavity part 13 is not specifically limited, examples of the thickness may be 0.07 to 9.9 mm. While the plate thickness in the laser melted part 17 of the tabular member 21 with relatively thinner plate thickness is not specifically limited, examples of the plate thickness may be 30 to 300 μm. The lower limit value of the plate thickness in the laser melted part 17 of the other tabular member 12 with relatively thicker plate thickness may be 100 μm, for example. While the upper limit value is not specifically limited, an example may be 9.97 mm.

While the thickness T12 of the laser melted part 17 in the other tabular member 22 is not specifically limited, the thickness T12 is preferable to be 50 to 400% of the plate thickness T1 in the laser melted part 17 of the tabular member 21, and more preferable to be 100 to 200%. While the maximum width W1 of the laser melted part 17 on the top surface of the container 20 is not specifically limited, the maximum width W1 is preferable to be 20 to 60% of the width W2 of the outer edge part 26 of the other tabular member 22, and more preferable to be 30 to 50%.

Like the vapor chamber according to the first embodiment, the energy density of the laser beam 15 can be reduced also with the vapor chamber 2 regardless of the kind of the material of the container 20, so that the heat generated at the time of laser welding can be inhibited and distortion of the container 20 can be reduced. Further, even when the material of the container 20 is cooper or aluminum with which pin-holes are easily generated in the laser melted part 17, generation of the pin-holes can be prevented. In addition, generation of sputter can be prevented also with the vapor chamber 2, so that contamination of the vapor chamber 2 as well as the welding jigs and the like can be prevented and no weld bead is generated in the other tabular member 22. Therefore, work for removing the weld bead can be omitted.

In addition, in the laser melted part 17 of the vapor chamber 2, the plate thickness of the tabular member 21 positioned on the laser irradiation side is thinner than the plate thickness of the other tabular member 22. Therefore, the energy density of the laser beam 15 can be reduced further, and distortion of the container 20 can be reduced further.

Next, a vapor chamber according to a third embodiment of the present disclosure will be described with reference to the accompanying drawings. Components same as the components of the vapor chambers according to the first and second embodiments of the present disclosure will be described by using same reference signs.

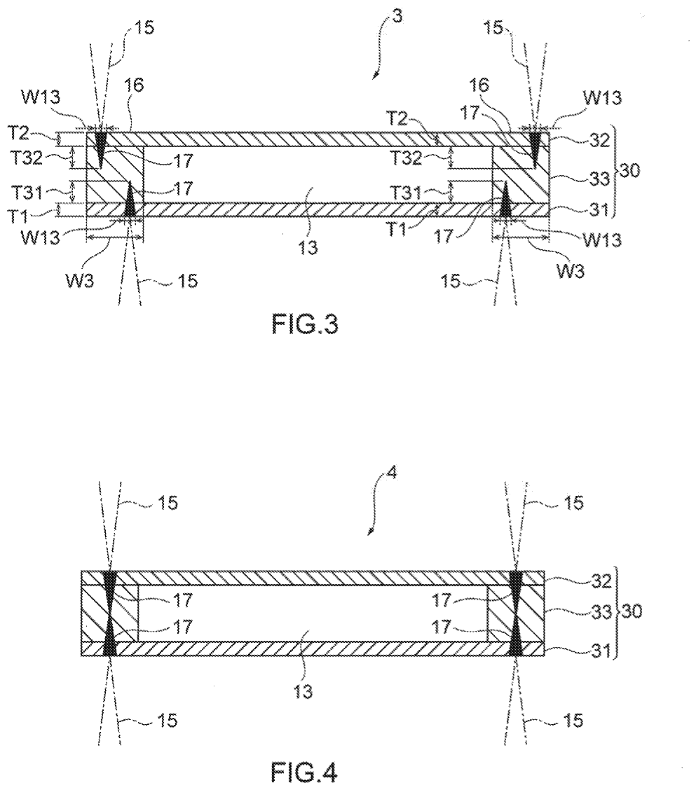

In the vapor chambers according to the first and second embodiments, the containers 10, 20 are formed in a double-layer structure, and the recessed part 14 viewed from the tabular members 11, 21 is provided in the center part of the other tabular members 12, 22. Instead, as shown in FIG. 3, in a vapor chamber 3 according to the third embodiment, a spacer member 33 is provided further between a tabular member 31 and another tabular member 32 facing the tabular member 31 to form a container 30. Accordingly, the container 30 is in a three-layer structure. The tabular member 31, the spacer member 33, and the other tabular member 32 are laminated at positions overlapping with each other on a plan view.

The spacer member 33 is a frame member. Each of the tabular member 31 and the other tabular member 32 is a flat-plate member. A recessed part viewed from the tabular member 31 is not provided in the center part of the tabular member 32. Thus, the spacer member 33 forms the cavity part 13 of the container 30. That is, a hollow part formed with an inner face of the other tabular member 32, an inner face of the tabular member 31, and an inner face of the spacer member 33 is the cavity part 13.

In the vapor chamber 3, the plate thickness of the tabular member 31 is substantially the same or the same as the plate thickness of the other tabular member 32 in the outer edge part 16 of the container 30 to be laser-welded. In the vapor chamber 3, the tabular member 31 and the spacer member 33 are joined through irradiating the laser beam 15 to the outer edge part 16 of the container 30 from the tabular member 31 side. Also, the other tabular member 32 and the spacer member 33 are joined through irradiating the laser beam 15 to the outer edge part 16 of the container 30 from the other tabular member 32 side.

In the tabular member 31 and the other tabular member 32 to which the laser beam 15 is irradiated, the laser melted part 17 runs through the tabular member 31 and the other tabular member 32 in the plate thickness direction. In the meantime, in the spacer member 33, the laser beam 15 irradiated from the tabular member 31 side does not run through the spacer member 33 in the thickness direction. In addition, in the spacer member 33, the laser beam 15 irradiated from the other tabular member 32 side does not run through the spacer member 33 in the thickness direction. That is, in the vapor chamber 3, the laser melted part 17 runs through the tabular member 31 and the other tabular member 32 in the plate thickness direction in the outer edge part 16 of the container 30 to be laser-welded, while the laser melted part 17 does not run through the spacer member 33 in the thickness direction.

Further, in the vapor chamber 3, the laser melted part 17 on the tabular member 31 side is provided at a position not facing the laser melted part 17 on the other tabular member 32 side.

From the above, a weld mark (for example, a weld bead is observed on the appearances of the tabular member 31 and the other tabular member 32 of the container 30.

While thickness T31 of the laser melted part 17 of the spacer member 33 on the tabular member 31 side is not specifically limited, the thickness T31 is preferable to be 50 to 400% of plate thickness T1 in the laser melted part of the tabular member 31, and more preferable to be 100 to 200%. Also, while thickness T32 of the laser melted part 17 of the spacer member 33 on the other tabular member 32 side is not specifically limited, the thickness T32 is preferable to be 50 to 400% of plate thickness T2 in the laser melted part 17 of the other tabular member 32, and more preferable to be 100 to 200%.

Maximum width W13 of the laser melted part 17 on the top surface of the container 30 is not specifically limited. However, the maximum width W13 is preferable to be 20 to 60% of width W3 of the frame itself of the spacer member 33 in the laser melted part 17 (that is, width of the spacer member 33 in the laser melted part 17), and more preferable to be 30 to 50%.

The thickness of the tabular member 31 and the thickness of the other tabular member 32 are not specifically limited, and examples may be 0.05 to 0.15 mm. The thickness of the spacer member 33 is not specifically limited. However, the thickness is preferable to be 0.5 to 2.0 mm, for example, and more preferable to be 0.6 to 0.8 mm. The width of the frame itself of the spacer member 33 is not specifically limited. However, the width is preferable to be 0.5 to 4.0 mm, for example, and more preferable to be 1.5 to 3.0 mm.

Like the vapor chambers according to the first and second embodiments, the energy density of the laser beam 15 can be reduced also in the vapor chamber 3 regardless of the kind of the material of the container 30, so that the heat generated at the time of laser welding can be inhibited and distortion of the container 30 can be reduced. Further, even when the material of the container 30 is copper or aluminum with which pin-holes are easily generated in the laser melted part 17, generation of the pin-holes can be prevented. In addition, generation of sputter can be prevented in the vapor chamber 3 as well.

Next, a vapor chamber according to a fourth embodiment of the present disclosure will be described with reference to the accompanying drawings. Components same as the components of the vapor chambers according to the first to third embodiments of the present disclosure will be described by using same reference signs.

In the vapor chamber 3 according to the third embodiment, the laser melted part 17 on the tabular member 31 side is provided at the position not facing the laser melted part 17 on the other tabular member 32 side. The position of the laser melted part 17 formed in the spacer member 33 is not specifically limited. As shown in FIG. 4, in a vapor chamber 4 according to the fourth embodiment of the present disclosure, the laser melted part 17 on the tabular member 31 side may be provided at a position facing the laser melted part 17 on the other tabular member 32 side instead.

Also, the laser melted part 17 on the tabular member 31 side may be or may not be in contact with the laser melted part 17 on the other tabular member 32 side. In the vapor chamber 4, the laser melted part 17 on the tabular member 31 side is in a mode of being in contact with the laser melted part 17 on the other tabular member 32 side.

Like the vapor chambers according to the first to third embodiments, the energy, density of the laser beam 15 can be reduced also in the vapor chamber 4 regardless of the kind of the material of the container 30, so that the heat generated at the time of laser welding can be inhibited and distortion of the container 30 can be reduced. Further, even when the material of the container 30 is copper or aluminum with which the pin-holes are easily generated in the laser melted part 17, generation of the pin-holes can be prevented. In addition, generation of sputter can be prevented in the vapor chamber 4 as well.

Next, a vapor chamber according to a fifth embodiment of the present disclosure will be described with reference to the accompanying drawings. Components same as the components of the vapor chambers according to the first to fourth embodiments of the present disclosure will be described by using same reference signs.

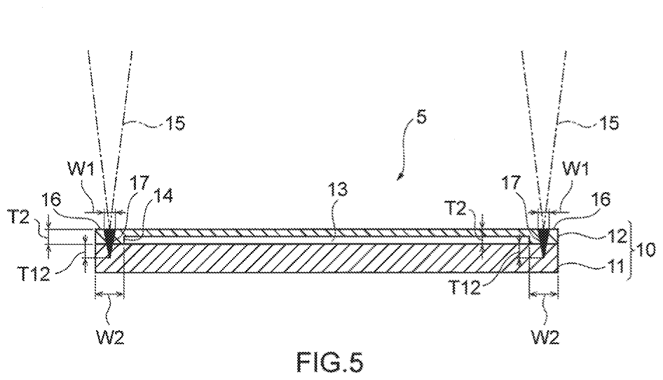

In the vapor chamber 1 according to the first embodiment, the laser beam 15 is irradiated to the tabular member 11 where the recessed part 14 forming the cavity part 13 is not provided, and the plate thickness of the tabular member 11 is the same or substantially the same as the plate thickness of the other tabular member 12 in the outer edge part 16 of the container 10 to be laser-welded. Instead, as shown in FIG. 5, in a vapor chamber 5 according to the fifth embodiment, in the outer edge part 16 of the container 10 to be laser-welded, the plate thickness of the tabular member 11 where the recessed part 14 forming the cavity part 13 is not provided is thicker than the plate thickness of the other tabular member 12 where the recessed part 14 is provided. Further, in the vapor chamber 5, the laser beam 15 is irradiated from the tabular member 12 side where the recessed part 14 is provided.

In the vapor chamber 5, in the outer edge part 16 of the container 10 to be laser-welded, the laser melted part 17 runs through the other tabular member 12 with relatively thinner plate thickness in the plate thickness direction while the laser melted part 17 does not run through the tabular member 11 with relatively thicker plate thickness in the plate thickness direction. That is, because the plate thickness of the other tabular member 12 is relatively thinner in the vapor chamber 5, the other tabular member 12 of the vapor chamber 5 corresponds to the tabular members 11, 21 of the vapor chambers 1, 2, while the tabular member 11 of the vapor chamber 5 corresponds to the other tabular members 12, 22 of the vapor chambers 1, 2. Therefore, in the vapor chamber 5, a welding mark (for example, a weld bead or the like) is observed on the appearance of the other tabular member 12 of the container 10, whereas no welding mark (for example, a weld bead or the like) is observed on the appearance of the tabular member 11 in the vapor chamber 2.

While the thickness of the vapor chamber 5 is not specifically limited, an example of the thickness may be about 0.3 mm. Further, while the plate thickness in the laser melted part 17 of the other tabular member 12 with relatively thinner plate thickness is not specifically limited, an example of the plate thickness may be about 0.1 mm. Also, while the plate thickness in the laser melted part 17 of the tabular member 11 with relatively thicker plate thickness is not specifically limited, an example of the plate thickness may be about 0.2 mm.

While the thickness T12 of the laser melted part 17 of the tabular member 11 is not specifically limited, the thickness 12 is preferable to be 50 to 400% of the plate thickness T2 in the laser melted part 17 of the other tabular member 12, and more preferable to be 100 to 200%. While the maximum width W1 of the laser melted part 17 on the top surface of the container 10 is not specifically limited, the maximum width W1 is preferable to be 20 to 60% of the width W2 of the outer edge part 16 of the other tabular member 12, and more preferable to be 30 to 50%.

Like the vapor chambers according to the first to fourth embodiments, the energy density of the laser beam 15 can be reduced also in the vapor chamber 5 regardless of the kind of the material of the container 10, so that the heat generated at the time of laser welding can be inhibited and distortion of the container 10 can be reduced. Further, even when the material of the container 10 is copper or aluminum with which the pin-holes are easily generated in the laser melted part 17, generation of the pin-holes can be prevented. In addition, generation of sputter can be prevented in the vapor chamber 5 as well.

Next, another embodiment of the vapor chamber according to the present disclosure will be described. In the vapor chambers according to the first, second, and fifth embodiments, the recessed part forming the cavity part is not provided in the center part of one of the tabular members. However, the recessed part may also be provided in that tabular member in addition to the other tabular member as necessary or may be provided to that tabular member alone instead. Further, in the vapor chambers according to the first, second, and fifth embodiments, the recessed part provided in the center part of the other tabular member mentioned above forms the cavity part. However, it is also possible to use the other tabular member whose center part is projected outward and plastic-deformed into a convex shape instead. In such case, the inner part of the convex shape forms the cavity part.

Further, in the vapor chambers according to the first and second embodiments, the plate thickness in the laser melted part of the tabular members (11, 21) is equal to or thinner than the plate thickness in the laser welded part of the other tabular members (12, 22). Instead, it is also possible to employ a mode in which the plate thickness in the laser melted part in the tabular members (11, 21) is thicker than the plate thickness of the other tabular members (12, 22).

Furthermore, while means for welding in the vapor chambers according to each of the embodiments is laser welding, the means for welding is not specifically limited. For example, seam welding, resistance welding, or the like may be employed as well.

With the vapor chamber according to the present disclosure, distortion of the container is reduced regardless of the kind of the material of the container. Therefore, the vapor chamber according to the present disclosure is of nigh utility value in the field of uniformly cooling the heating elements as cooling subjects in a planar manner.

What is claimed is:

1. A vapor chamber comprising: a container having a hollow cavity part, the container being formed by laminating one tabular member and another tabular member facing the one tabular member; a working fluid enclosed in the cavity part; and a wick structure provided in the cavity part, an outer peripheral part of the cavity part being sealed by welding, wherein
a melted part formed by the welding runs through the one tabular member, while the melted part does not run through the other tabular member.

2. A vapor chamber comprising: a container having a hollow cavity part, the container being formed by laminating one tabular member, another tabular member facing the one tabular member, and a spacer member provided between the one tabular member and the her tabular member; a working fluid enclosed in the cavity part; and a wick structure provided in the cavity part, an outer peripheral part of the cavity part being sealed by welding, wherein
a melted part formed by the welding runs through the one tabular member, while the melted part on the one tabular member side does not run through the spacer member, and
the melted part runs through the other tabular member, while the melted part on the other tabular member side does not run through the spacer member.

3. The vapor chamber according to claim 1, wherein
plate thickness in the melted part of the one tabular member is thinner than plate thickness in the melted part of the other tabular member.

4. The vapor chamber according to claim 3, wherein
thickness of the melted part of the other tabular member is 50 to 400% of the plate thickness in the melted part of the one tabular member.

5. The vapor chamber according to claim 2, wherein:
thickness of the melted part of the spacer member on the one tabular member side is 50 to 400% of plate thickness in the melted part of the one tabular member; and thickness of the melted part of the spacer member on the other tabular member side is 50 to 400% of plate thickness in the melted part of the other tabular member.

6. The vapor chamber according to claim 2, wherein
maximum width of the melted part on a top surface of the container is 20 to 60% of width of the spacer member in the melted part.

7. The vapor chamber according to claim 1, wherein
a recessed part forming the cavity part is provided in the other tabular member.

8. The vapor chamber according to claim 3, wherein:
a recessed part forming the cavity part is provided in the other tabular member; the plate thickness in the melted part of the one tabular member is 30 to 300 μm; and the plate thickness in the melted part of the other tabular member is 100 μm or more.

9. The vapor chamber according to claim 1, wherein
thickness of the melted part of the other tabular member is 10 to 90% of plate thickness in the melted part of the other tabular member.

10. The vapor chamber according to claim 1, wherein
the welding is laser welding, and the melted part is a laser melted part.

11. The vapor chamber according to claim 1, wherein
a material of the container is at least one kind of metal selected from a group consisting of stainless steel, copper, copper alloy, aluminum, aluminum alloy, tin, tin alloy, titanium, titanium alloy, nickel, and nickel alloy.
